(19) United States
(12) Patent Application Publication
(10) Pub. No.: US 2024/0346148 A1
(43) Pub. Date: Oct. 17, 2024

(54) METHODS FOR WEB CONTAINER SECURITY PATCHING

(71) Applicant: OPEN TEXT HOLDINGS, INC., Menlo Park, CA (US)

(72) Inventor: Dhatchana Moorthy Sekar, Bangalore (IN)

(21) Appl. No.: 18/635,813

(22) Filed: Apr. 15, 2024

Related U.S. Application Data
(60) Provisional application No. 63/615,065, filed on Dec. 27, 2023.

(30) Foreign Application Priority Data
Apr. 14, 2023 (IN) 202341027545

(51) Int. Cl. G06F 21/57

(52) U.S. Cl. CPC G06F 21/572; G06F 21/577; G06F 2221/033

(57) ABSTRACT

A system and method enables improved container security patching in a container orchestration cloud environment. The systems and methods provide several advantages over traditional methods, for example, by enabling the release of only one hardened base image for multiple products. In some embodiments, upon the reporting of a vulnerability, the systems and methods bifurcates a third party image (a base image) from a product image. Therefore, when a vulnerability occurs in the base image, an organization can ship only the base container image, rather than the product image, which avoids the development and testing processes that would otherwise be required.

### CROSS-REFERENCE TO RELATED APPLICATIONS

This application claims a benefit of priority under 35 U.S.C. § 119 (e) from U.S. Provisional Application No. 63/615,065, filed Dec. 27, 2023, entitled “METHODS FOR WEB CONTAINER SECURITY PATCHING,” and Indian patent application Ser. No. 20/234,1027545, filed Apr. 14, 2023, entitled “METHODS FOR WEB CONTAINER SECURITY PATCHING,” the contents of which are fully incorporated by reference herein for all purposes.

### TECHNICAL FIELD

This disclosure relates generally to the field of content management. In particular, this disclosure relates to systems, methods, and computer program products for providing improved container security patching in a container orchestration cloud environment.

### BACKGROUND

Containerization relates to an application-level virtualization over multiple network resources enabling software applications to run in isolated user spaces called containers in a cloud or non-cloud environment. In some examples, containers are basically fully functional and portable cloud or non-cloud computing environments surrounding an application and keeping the application independent from other parallel environments. In some uses, each container simulates a different software application and runs isolated processes by bundling related configuration files, libraries and dependencies. Container deployment is the act of deploying containers to their target environment, such as a cloud or on-premises server. In some examples, containers are deployed by a container orchestration platform, such as Kubernetes, Docker Swarm, or similar tools, as one skilled in the art would understand. Such container orchestration platforms typically provide mechanisms to manage the lifecycle of containers, including tasks related to deployment, updating, monitoring, etc.

Cloud customers of an organization often face security issues with third party (non-product) components. Typically, the cloud customers cannot patch the non-product components independently, and have to wait for the organization to provide patch. Thus, the patching process is slow and inefficient.

In a conventional delivery model, organizations package the operating system (OS), Java, application server software, and product library together and customers have to wait (sometimes for multiple weeks or more) to get a patch. This delay could even result in service level agreement (SLA) violations. One challenge is that a considerable amount of time may be spent in building non-product security patches across different products and cloud release versions.

In view of the foregoing, there is room for innovations and improvements for providing security patches in a container orchestration environment.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, or rearrangements may be made within the scope of the disclosure without departing from the spirit thereof, and the disclosure includes all such substitutions, modifications, additions, or rearrangements.

### SUMMARY

In some embodiments, containerization systems and methods are described that, responsive to detecting a security vulnerability in a software application, build a new base application image, deploy the new base application image, update a helm chart with the new base application image, and update a product container with the new base application image. Embodiments of the present invention also include computer-readable storage media containing sets of instructions to cause one or more processors to perform the methods, variations of the methods, and other operations described herein.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 is a flow chart outlining an approach to addressing security vulnerabilities in a containerization environment.

FIG. 2 is a flow chart outlining an approach to addressing security vulnerabilities in a containerization environment using a common base app server image.

FIG. 3 is a sequence diagram for an exemplary process as depicted in the flow chart of FIG. 2.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

For the purposes of this description, it may be helpful to understand the operation of a customizable containerization framework for deploying containers in a container orchestration cloud environment. Commonly-owned U.S. patents applications Ser. Nos. 18/151,271, entitled “CUSTOMIZABLE CONTAINERIZATION FRAMEWORK SYSTEM AND METHOD,” filed on Jan. 6, 2023 and 18/151,273, entitled “CUSTOMIZABLE CONTAINERIZATION FRAMEWORK SYSTEM AND METHOD,” filed on Jan. 6, 2023, each describe embodiments of customizable containerization frameworks, and are incorporated herein by reference in their entireties for all purposes.

Generally, the present disclosure describes a system and method for providing improved container security patching in a container orchestration cloud environment. The disclosed solutions provide several advantages over traditional methods. For example, in some embodiments, only one hardened base image is released for multiple products. In some embodiments, it is expected to achieve more than 30% savings in efforts relating to security patches delivery. In some examples, security patches can be delivered quickly (sometimes just days or less). This rapid delivery is more likely to fall within SLA guidelines, compared to traditional system. The disclosed methods also enable self-patch capability for customers to fix non-product vulnerabilities.

Periodically, an organization will receive reports of a vulnerability in one of the libraries that it is using with a product. Ideally, it is desirable to patch the vulnerability as soon as possible. With a traditional solution, the organization gets a new image and then builds the product image. Since a new product image is built, the new image has to go through a development and testing process, which introduces additional effort and delay. The solutions described herein bifurcates the third party image (e.g., the base Tomcat image) from the product image. Therefore, whenever a vulnerability occurs in the base Tomcat image, the organization can ship only the Tomcat based container image, and not the product image, which avoids the development and testing processes that would otherwise be required.

Following is a description summarizing embodiments of the disclosed solution. A more detailed description follows. First, an initial (init) container pattern is used where the product image is inserted as an extension to the base Tomcat image. Note that a Tomcat image refers to a container image that contains an Apache Tomcat web server software, along with any required dependencies and configurations. Also note that the described concepts apply to other exemplary applications and other types of container images. In this example, the base Tomcat image is extended from the hardened Tomcat image maintained by a unified build management (UBM) team and only one image is maintained for all client applications. Optionally, a template Dockerfile (a text file containing a set of instructions for building a Docker image) will be provided to the customers such that customers can maintain their own Tomcat images. The described process provides a seamless upgrade from older versions.

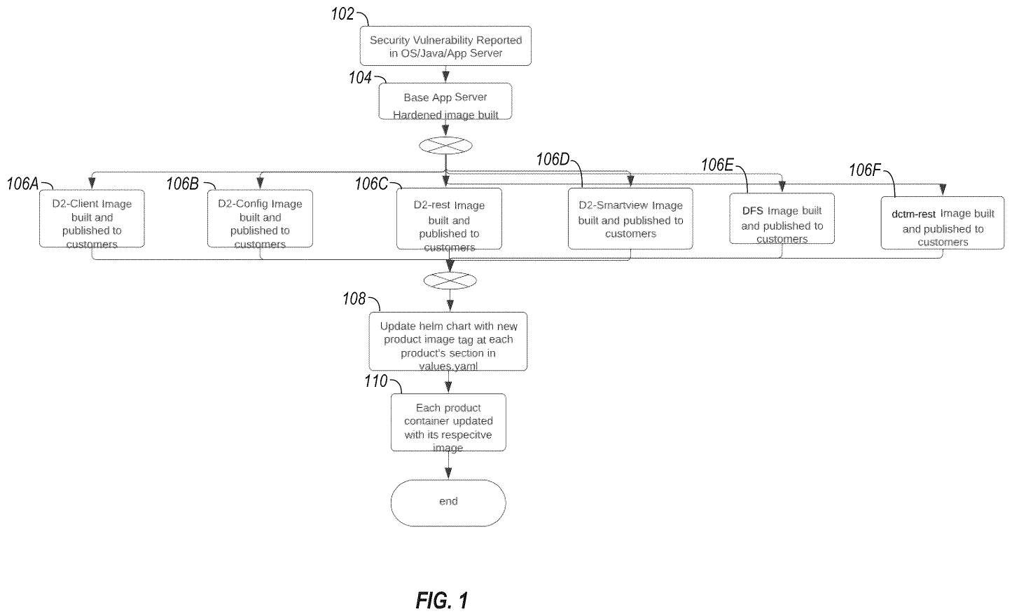

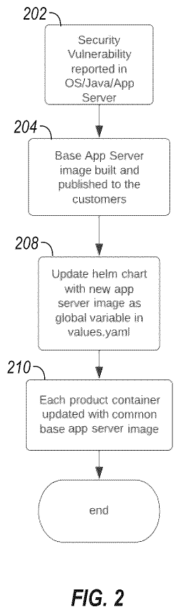

FIGS. 1 and 2 are flow charts outlining two approaches to addressing security vulnerabilities in a containerization environment. The process of FIG. 1 begins at step 102 with a security vulnerability reported in the OS, Java, or App Server. Next, at step 104, a base App Server hardened image is built. Since the enterprise product includes many services, there are many containers (steps 106A, 106B, 106C, 106D, 106E, 106F). In the example of FIG. 1, 6 containers (D2 client image, D2 config image, D2 rest image, D2 smartview image, DFS image, dctm-rest image) are shown being built and published to customers. Other examples are also possible. Once all of the images are published to customers, the helm chart is updated (step 108) with a new product image tag at each product's section in a yaml file format (e.g., values.yaml). At step 110, each product container is updated with its respective image.

FIG. 2 shows another approach to address security vulnerabilities that provides improvements over other approaches. As discussed above, ideally, it is desirable to patch the vulnerabilities as soon as possible. Note that, with other approaches, when an organization gets a new image, it then builds the product image, which has to go through a development and testing process, which introduces additional effort and delay. The approach illustrated in FIG. 2 bifurcates the third party image (e.g., the base Tomcat image, in the example of implementations using Apache Tomcat web server software) from a customer's product image. Therefore, whenever a vulnerability in the base image is reported, the organization can ship only the based image, and not the product image, which avoids the development and testing processes that would otherwise be required.

The process of FIG. 2 begins at step 202 with a security vulnerability reported in the OS, Java, or App Server. Next, at step 204, a base app server image (in the example of a web server environment) is built and published to customers. In the example of implementations using Apache Tomcat web server software, the base app image may be referred to as a base Tomcat image. Next, at step 208, the helm chart is updated with the new app server image in one global variable in a yaml file (e.g., values.yaml).

At step 210, each product container is updated with the common base app server image. As one skilled in the art would understand, this approach enables the release of only one hardened base image for multiple products, resulting in significant improvements to security patch delivery. As discussed above, such improvements include the speed that security patches can be delivered. Another advantage is that this approach enables self-patch capabilities for customers to fix non-product vulnerabilities.

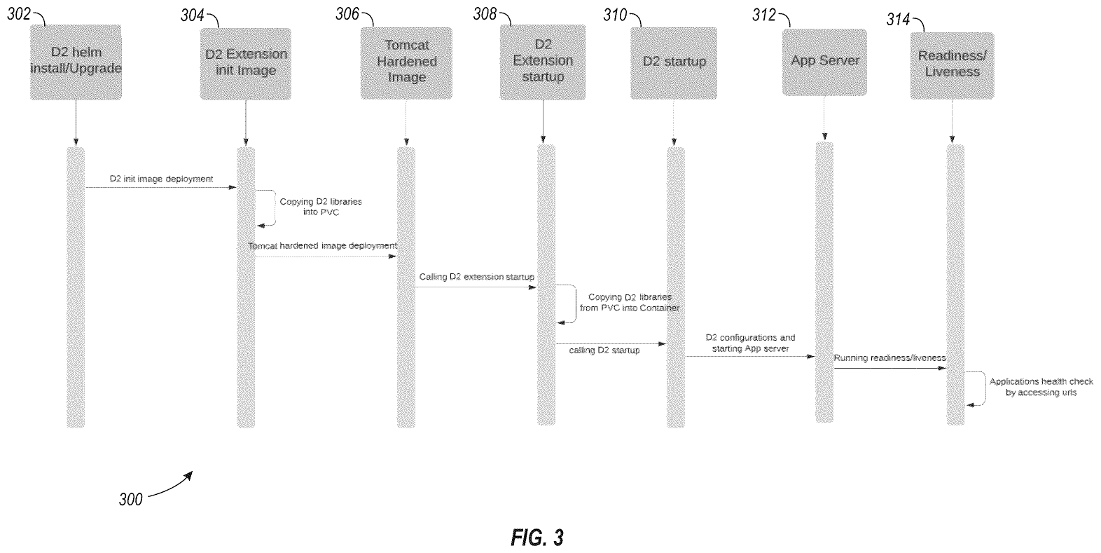

FIG. 3 shows a sequence diagram 300 of an exemplary process as depicted in FIG. 2. The sequence diagram of FIG. 3 will be described in the context of the example of implementations using Apache Tomcat web server software, although other examples are also possible, as one skilled in the art would understand. First, a D2 Helm install/upgrade command 302 is shown for deploying images. As sown, this deploys an init container image for D2. When the D2 extension init image 304 deploys, D2 libraries are copied into PVC (persistent volume client) and the Tomcat hardened image 306 is deployed. Next, the D2 extension startup 308 is called, and the D2 libraries are copied from PVC into the container. Next, the D2 startup 310 is called, and the App Server 312 is started. Next, Readiness/Liveness 314 is run and the application health is checked by accessing URLs. Other examples are also possible.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the

drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A method of containerization, comprising:
responsive to detecting a security vulnerability in a software application, building a new base application image;
deploying the new base application image;
updating a helm chart with the new base application image; and
updating a product container with the new base application image.

2. The method of claim 1, wherein the new base application image is deployed by a container orchestration platform.

3. The method of claim 1, wherein the new base application image contains a web server application.

4. The method of claim 3, wherein the web server application is an Apache web server application.

5. The method of claim 1, wherein the security vulnerability comprises a vulnerability in a library used by an application contained by the new base application image.

6. The method of claim 1, wherein a base application image is provided to a user to use with a user's application.

7. The method of claim 6, wherein the deployment of the new base application image enables the user to fix the security vulnerability.

8. A system for containerization, comprising:
a processor;
a non-transitory computer-readable medium; and
stored instructions translatable by the processor for executing:
responsive to detecting a security vulnerability in a software application, building a new base application image;
deploying the new base application image;
updating a helm chart with the new base application image; and
updating a product container with the new base application image.

9. The system of claim 8, wherein the new base application image is deployed by a container orchestration platform.

10. The system of claim 8, wherein the new base application image contains a web server application.

11. The system of claim 10, wherein the web server application is an Apache web server application.

12. The system of claim 8, wherein the security vulnerability comprises a vulnerability in a library used by an application contained by the new base application image.

13. The system of claim 8, wherein a base application image is provided to a user to use with a user's application.

14. The system of claim 13, wherein the deployment of the new base application image enables the user to fix the security vulnerability.

15. A computer programming product comprising a non-transitory computer-readable medium storing instructions for containerization, the instructions translatable by a processor for:
responsive to detecting a security vulnerability in a software application, building a new base application image;
deploying the new base application image;
updating a helm chart with the new base application image; and
updating a product container with the new base application image.

16. The computer programming product of claim 15, wherein the new base application image is deployed by a container orchestration platform.

17. The computer programming product of claim 15, wherein the new base application image contains a web server application.

18. The computer programming product of claim 17, wherein the web server application is an Apache web server application.

19. The computer programming product of claim 15, wherein the security vulnerability comprises a vulnerability in a library used by an application contained by the new base application image.

20. The computer programming product of claim 15, wherein a base application image is provided to a user to use with a user's application, and wherein the deployment of the new base application image enables the user to fix the security vulnerability.
